(19) United States
(12) Patent Application Publication
(10) Pub. No.: US 2022/0281244 A1
(43) Pub. Date: Sep. 8, 2022

(54) MEDIA ROLL SLIPPAGE DETERMINATION

(71) Applicant: HEWLETT-PACKARD DEVELOPMENT COMPANY, L.P., Spring, TX (US)

(72) Inventors: Albert Estella Aguerri, Sant Cugat del Valles (ES); David Munoz Navarro, Sant Cugat del Valles (ES); Francisco Guerrero Carvajal, Sant Cugat del Valles (ES)

(73) Assignee: HEWLETT-PACKARD DEVELOPMENT COMPANY, L.P., Spring, TX (US)

(21) Appl. No.: 17/634,753

(22) PCT Filed: Sep. 26, 2019
(86) PCT No.: PCT/US2019/053271

§ 371 Date: Feb. 11, 2022

(51) Int. Cl. B41J 11/42

(52) U.S. Cl. CPC B41J 11/42

(57) ABSTRACT

A system is disclosed. The system comprises a roller with a spindle to wind and/or unwind a roll of media, a media advancement sensor to measure the advancement of the media, and a controller. The controller is to control the spindle to rotate an angular displacement, and to determine a calculated media advancement based on the angular displacement and a radius of the roll of media. The controller is also to receive from the media advancement sensor a measured media advancement. The controller is further to detect that a displacement difference between the measured media advancement and the determined media advancement exceeds a predetermined threshold. If the displacement difference exceeds the predetermined threshold a slippage condition is detected.

### BACKGROUND

Printers are systems that generate printed images by propelling printing fluid through nozzles onto printing media locations associated with virtual pixels. The printing fluid drops may comprise pigments or dyes disposed in a liquid vehicle. The media may move with respect the inkjet printer with the aid of a media conveying system.

### BRIEF DESCRIPTION OF THE DRAWINGS

The present application may be more fully appreciated in connection with the following detailed description of non-limiting examples taken in conjunction with the accompanying drawings in which like reference characters refer to like parts throughout and in which:

FIG. 1 is a schematic diagram showing an example of a system to detect a slippage condition.

FIG. 2 is a flowchart of an example method for detecting a slippage condition.

FIG. 3 is a flowchart of another example method for detecting a slippage condition.

FIG. 4 is a schematic diagram showing an example of another system to detect a slippage condition.

FIG. 5 is a flowchart of another example method for detecting a telescopic effect.

FIG. 6 is a block diagram illustrating an example of a processor-based system to detect a telescoping effect.

### DETAILED DESCRIPTION

Some examples of the following description may be directed to various examples related to printing systems, apparatuses and processes to generate high quality printed objects. Throughout the present disclosure, the terms “a” and “an” are intended to denote at least one of a particular element. In addition, as used herein, the term “includes” means includes but not limited to, the term “including” means including but not limited to. The term “based on” means based at least in part on.

For simplicity, it is to be understood that in the present disclosure, elements with the same reference numerals in different figures may be structurally the same and/or may perform the same functionality.

Some printers, such as Large Format Printers, comprise media conveying systems to transfer an amount of media from one place to another with respect to a media advancement axis. In some examples, the media conveying systems may transfer media, rolled in a media input roller, to a media output roller located at the opposite side of the printing zone. These examples may be referred to as the so-called roll-to-roll conveying systems. In other examples, however, the amount of media may be transferred in a linear way through the printing zone. In yet other examples, the amount of media may be transferred from a media input roller in a linear way through the printing zone, these examples may be referred to as the so-called roller-to-sheet conveying systems.

Some printing systems may print images on paper. Other printing systems may print images on a textile media.

Some textile printing systems may eject printing fluids directly to the media that is intended to be part of the final product. These systems may be referred to as direct-to-fabric (DTF) printing systems if the media is a textile. Other textile printing systems may eject printing fluid to an intermediate fabric which is used to transfer the printed image to a different media (e.g., transfer media) intended to be part of the final product. The image transfer may be executed, for example, through a calendar sublimation system. These systems may be referred to as transfer-to-fabric (TTF) printing systems if the final media is a textile.

Some transfer media may have a lower grammage compared to the media intended to be part of the final product. A lower grammage (e.g., lower density) media enables the load of larger media rolls into the printing system and comply to the corresponding load weight requirements. In some cases, these low grammage transfer media may also involve a lower superficial friction between the layers of media in the media roll they are winded onto.

Low friction media layers in large media rolls may be affected by inter-layer slippage, also known as telescoping effect. In an example, this effect may appear because the torque from the motor may be transmitted by the spindle to the roll and the low friction between inter-faces of the roll may not withstand the aforementioned torque.

The telescopic effect may involve that a part between two consecutive layers of the media roll starts to relatively displace laterally with respect to the overall media roll, thereby increasing the width of the media roll. Furthermore, the slippage effect may also cause a differential advancement of the media, in the media conveying system, relative to the advancement that the media is intended to advance. This relative advancement may lead to instability on the media conveying system causing image quality defects. The telescopic effect may magnify in high motor torques to be transmitted through, for example, large media rolls.

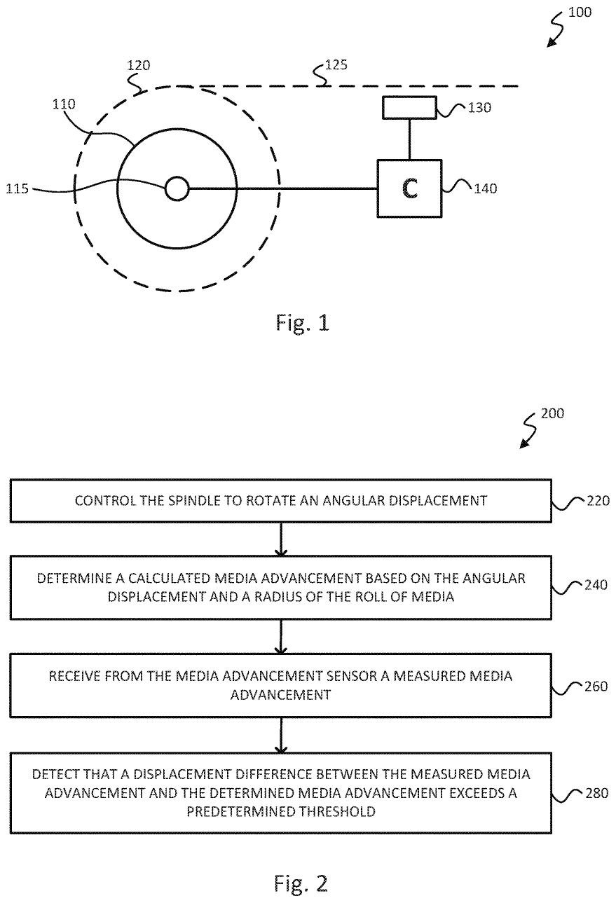

Referring now to the drawings, FIG. 1 is a schematic diagram showing an example of a system 100 to detect a slippage condition. The system 100 comprises a roller 110 with a spindle 115.

In the examples herein, the spindle 115 may be understood as a rotating axis or shaft physically connected, or connectable, to the roller 110. The rotation of the spindle 115 may be provided through a motor or any suitable rotating device. The rotation of the spindle 115 is transferred to the roller 110.

The roller 110 is to wind and/or unwind a roll of media 120. In some examples, the roll of media 120 may comprise a plurality of layers of media rolled up onto the roller 110. In other examples, the roll of media 120 may not comprise any layer of media onto the roller 110 and it is intended to be subsequently winded with layers of media. The roll of media 120 is illustrated in dotted lines to denote that it is an external element that interacts with the system 100, and thereby it is not an integral part of the system 100 as such.

In an example, the media from the roll of media 120 may be a transfer media. In other examples, the media from the roll of media 120 may be a media that is intended to be part of the final product. In the examples herein, the term media may comprise any media suitable to be printed thereon. Some examples of media may include paper, textile, cardboard, tin, and/or metal.

The system 100 may also comprise a media advancement sensor 130 to measure the advancement of the media 125 to be sensed (referred hereinafter as media 125). In an example, the media 125 may be an unwinded part of the roll of media 120. In another example, the media 125 may be media to be winded on the roll of media 120. The media advancement sensor 130 may be, for example, an optical media advancement sensor. In other examples, the media advancement sensor 130 may include a physical sensor, such as, a touch sensor, a contact sensor or a pressure sensor. In any case, the media advancement sensor 130 may be any sensor suitable to measure the advancement of the media 125.

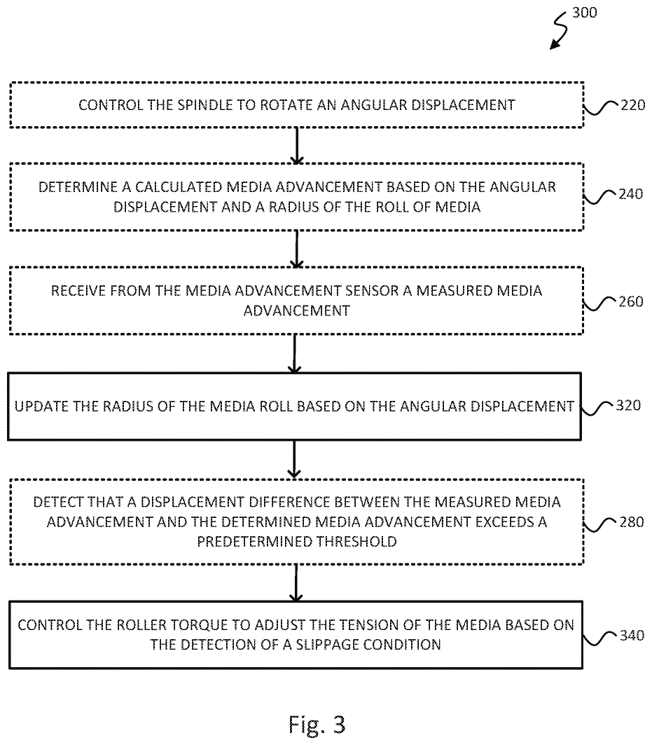

The system 100 further includes a controller 140. The controller may be coupled to the spindle 115 (or any rotating engine connectable to the spindle 115) through wired or wireless connections, and to the media advancement sensor 130. In these examples, the controller 140 may control the rotation of the spindle 115 and may be suitable to receive measurements from the media advancement sensor 130. The functionality of the controller 140 is disclosed and may be more fully appreciated with reference to the execution of method 200 from FIG. 2, method 300 from FIG. 3, and/or method 500 from FIG. 5.

In the examples herein, a controller may be any combination of hardware and programming that may be implemented in a number of different ways. For example, the programming of modules may be processor-executable instructions stored in at least one non-transitory machine-readable storage medium and the hardware for modules may include at least one processor to execute those instructions. In some examples described herein, multiple modules may be collectively implemented by a combination of hardware and programming. In other examples, the functionalities of the controller may be, at least partially, implemented in the form of an electronic circuitry. The controller may be a distributed controller, a plurality of controllers, and the like.

FIG. 2 is a flowchart of an example method 200 for detecting a slippage condition. Method 200 is described below as being executed or performed by a controller, such as the controller 140 of FIG. 1. Method 200 may be implemented in the form of executable instructions stored on a machine-readable storage medium and executed by a single processor or a plurality of processors, and/or in the form of any electronic circuitry, for example digital and/or analog ASIC. In some implementations of the present disclosure, method 200 may include more or less elements than are shown in FIG. 2. In some implementations, some of the elements of method 200 may, at certain times, be performed in parallel and/or may repeat.

At block 220, the controller 140 may control the spindle 115 to rotate an angular displacement. In an example, the angular displacement may correspond to the angular displacement that is to wind or unwind a preset amount of media. The preset amount of media may correspond to the width, or part of the width, of a printhead assembly so that a printing device may print is a scanning mode. In another example, the angular displacement may be continuous and refreshed periodically so that it may be suitable for page-wide printhead array printing systems that are able to print in a continuous manner.

In some examples, the angular displacement may be below about 5°. In other examples, the angular displacement may range from about 5° to about 50°. In other examples, the angular displacement may range from about 45° to about 90°. In other examples, the angular displacement may range from about 85° to about 135°. In other examples, the angular displacement may range from about 130° to about 180°. In other examples, the angular displacement may range from about 175° to about 225°. In other examples the angular displacement may range from about 220° to about 270″. In other examples, the angular displacement may range from about 265° to about 315°. In other examples the angular displacement may range from about 310° to about 360°. In yet other examples the angular displacement may be above about 360°.

At block 240 the controller 140 is to determine a calculated media advancement. In an example, the calculated media advancement may be received from an external sensor or processing entity (not shown). In another example, the controller 140 is to execute some programming to determine the calculated media advancement. The calculated media advancement is based on the angular displacement, previously displaced by the spindle 115, and a radius of the roll of media 120, for example, the external radius of the roll of media 120. The radius of the roll of media 120 may be either calculated or measured. Since the calculated media advancement is determined through the angular displacement, it may indicate the theoretical media advancement corresponding to the angular displacement. Thereby, the calculated media advancement may not include the media advanced due to the effects of any potential slippage that may have occurred within the media roller 120 during the angular displacement.

At block 260, the controller 140 is to receive from the media advancement sensor 130 a measured media advancement. The media advancement sensor 130 may measure the media advancement corresponding to the media 125. The measured media advancement may indicate the real displacement occurred in the roll of media 120 due to the rotation of the spindle 115. Thereby, the measured media advancement may include every cause of media displacement, including any potential slippage that may have occurred within the media roller 120 during the angular displacement.

At block 280, the controller 140 is to determine a displacement difference between the measured media advancement (e.g., block 260) and the determined media advancement (e.g., block 240). The controller 140 is further to detect whether the determined displacement difference exceeds a predetermined threshold. The predetermined threshold may indicate whether a substantial slippage occurred during the angular displacement from the spindle 115. The predetermined threshold may be selected taking the image quality requirements into account. The controller 140 may detect that a slippage condition occurred if the displacement difference exceeds the predetermined threshold.

FIG. 3 is a flowchart of another example method 300 for detecting a slippage condition. Method 300 may also be executed by controller 140 from FIG. 1. Blocks 220-280 from method 300, indicated in dotted lines, may be the same as or similar to blocks of method 200 from FIG. 2 with the same reference numerals. Additionally, method 300 may comprise block 320, block 340, or both blocks 320 and 340.

In an example, after executing the angular displacement and thereby the corresponding media 125 displacement, the radius of the roll of media 120 may have increased, if the roller 110 has winded the displaced media 125; or decreased, if the roller 110 has unwinded the displaced media 125. At block 320, the controller 140 may update the radius of the media roll 120 based on the angular displacement. The updated radius may be used in, for example, the following iteration of block 240. In additional examples, block 320 may be executed by an external processing device (e.g., external controller, CPU, SoC, ASIC, or the like) and be subsequently sent to the controller 140. Block 320 has been illustrated after block 260, however, it is to be understood that block 320 may be executed after any of the blocks 220-340.

As it has been disclosed above the slippage or telescopic effect may be corrected by adjusting the tension between the inter-layers of media within the roll of media 120. Additionally, or alternatively, at block 340, upon detecting a slippage condition (e.g., block 280), the controller 140 may control the roller 115 torque to adjust the tension of the inter-layers of media from the media roll 120. In another example, the controller 140 may trigger a sound emitter (e.g., alarm, speaker, siren, or the like) upon detecting that a slippage condition occurred, in order to alert a user or technician to modify the tension within the inter-layers of media from the media roll 120.

In the example of block 340, the controller 140 may control the roller torque through, for example, instructing a rotating engine connectable to the spindle 115 to modify the torque transferred to the spindle 115 and subsequently to the roller 110. The controller 140 may control the roller 110 torque while the roller 110 is either winding or unwinding the media 125 thereon, thereby observing the potential image quality deficiency due to a slippage condition in the roll of media 120 while the system 100 is in use. The controller 140 may also control the roller 110 torque while the system 100 is not in use or is in between print jobs.

The controller 140 may adjust the roller torque of the roller 110 and, thereby, the tension in between inter-layers of media within the roll of media 120 based on, for example, at least one of the radius of the roller, the media friction coefficient, the number of layers of the media on the roll of media 120, the roll of media 125 weight and the actual roller 110 torque. Additionally, or alternatively, the controller 140 may control the roller 110 torque based on, for example, at least one of a composition of the media, the nature of the media fibers, the ambient temperature, and the ambient humidity.

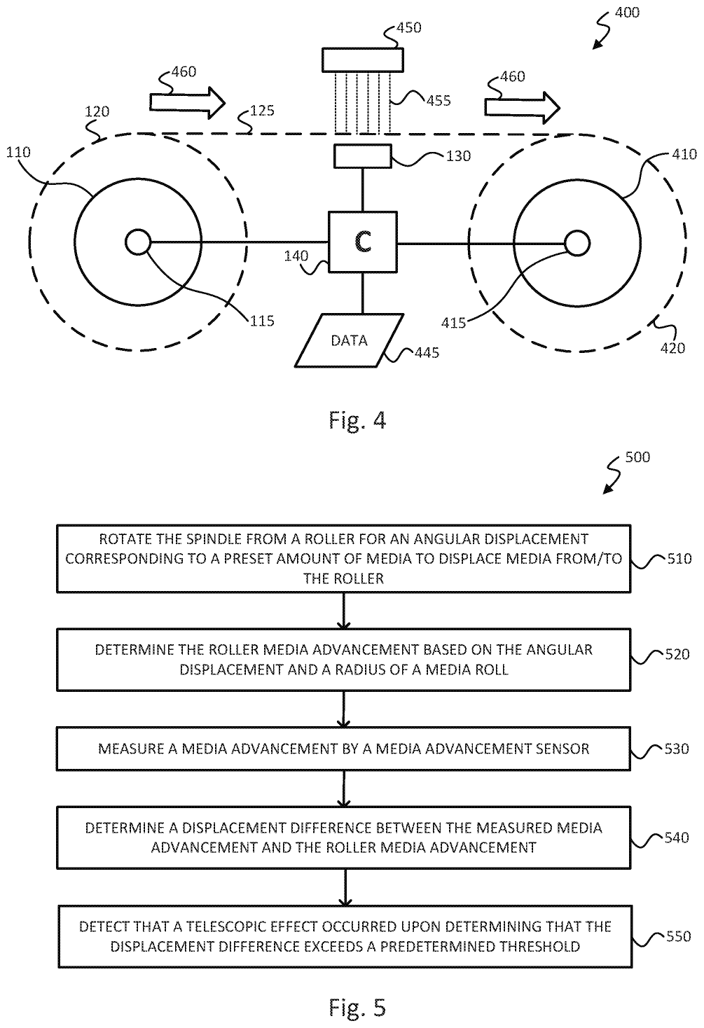

FIG. 4 is a schematic diagram showing an example of another system 400 to detect a slippage condition.

System 400 comprises a media input roller 110 with an input roller spindle 115 wherein an input roll of media 120 is winded around the media input roller 110. The system 400 further comprises a media output roller 410 with an output roller spindle 415 wherein an output roll of media 420 is winded (or to be winded) around the media output roller 410. The media input roller 110 and the media output roller 410 may be the same as or similar to the roller 110 from FIG. 1. The spindle 115 and the spindle 415 may be the same as or similar to the spindle 115 from FIG. 1. The input roll of media 120 and the output roll of media 420 may be the same as or similar to the roll of media 120 from FIG. 1.

The system 400 also comprises the controller 140 which may control the movement of the media input roller 110 and the media output roller 410 through the input roller spindle 115 and the output roller spindle 415 respectively. The media input roller 110 is to rotate to unwind media from the input roll of media 120, which may travel (e.g., illustrated as conveyed media 125) along direction 460 towards the media output roller 410. The media output roller 410 may rotate to wind the received media, originally from the input toll of media 120, around the output roll of media 420. In some examples, the rotation of the input roller spindle 115 and the output roller spindle 415 may be synchronous. In other examples, the rotation of the input roller spindle 115 and the output roller spindle 415 may be asynchronous.

Even though the input roll of media 120 the conveyed media 125, and the output roll of media 420 are illustrated with different reference numerals, it is to be understood that they may be a single continuous sheet of media. The input roll of media 120, the conveyed media 125, and the output roll of media 420 are illustrated in dotted lines to denote that they are external elements that interact with the system 400, and thereby they are not an integral part of the system 400 as such.

The system 400 also comprises the media advancement sensor 130 to measure the advancement of the conveyed media 125.

The controller 140 is to detect if a slippage condition or telescopic effect has occurred by executing, for example, method 200 from FIG. 2 or method 300 from FIG. 3. Upon detecting that a slippage condition has occurred, the controller 140 is to control the media input roller 110 torque and the media output roller 410 torque to adjust the tension of the media to observe the potential image quality deficiency. In some examples, the controller 140 is to decrease the media input roller 110 torque and the media input roller 410 torque as the input roll of media 120 radius decreases and the output roll of media 420 radius increases.

In some examples, the system 400 is a printing system and further comprises a printing module 450. The printing module 450 may be coupled to the controller 140 and the controller 140 may control the printing module 450 to perform the functionality disclosed herein. The controller 140 may receive data 445 including an image to be printed. The printing module 450 may be any suitable sub-system to eject printing fluid 455 on the conveyed media 125 based on the image to be printed. The printing module 450 may comprise at least one printhead (not shown).

Each printhead may comprise an array of nozzles that may eject a corresponding amount and/or type of printing fluid 455. In some examples, the printhead may be a thermal inkjet printhead. In other examples, the printhead may be piezoelectric inkjet printhead. Some examples of printheads have been disclosed, however any other printhead suitable to selectively eject an amount of a printing fluid 455 may be used without departing from the scope of the present disclosure.

In an example, the printing fluid 455 may comprise a colorant and/or dye with a liquid carrier; e.g., in cartridges and/or liquid toners (not shown). Some printing fluids 455 may be dye based printing fluids, where dyes may be understood as a coloring solution. Other printing fluids 455 may be pigment based printing fluids, where pigments may be understood as coloring particles in suspension. In another example, the printing fluid 455 may comprise ink particles and an imaging oil liquid carrier. A plurality of examples of the printing fluid 455 that may be propelled by, for example, a nozzle from the printing module 450 have been disclosed, however any other chemical printing fluid 455 comprising an agent in a liquid solvent or in a liquid carrier that may evaporate in contact with ambient air may be used without departing from the scope of the present disclosure.

FIG. 5 is a flowchart of another example method 500 for detecting a telescopic effect. Parts of the method 500 is described below as being executed or performed by a controller, such as the controller 140 of FIG. 1. Method 500 may be implemented in the form of executable instructions stored on a machine-readable storage medium and executed by a single processor or a plurality of processors, and/or in the form of any electronic circuitry, for example digital and/or analog ASIC. In some implementations of the present disclosure, method 500 may include more or less elements than are shown in FIG. 5. In some implementations, some of the elements of method 500 may, at certain times, be performed in parallel and/or may repeat.

At block 510, the spindle 115 from a roller 110 rotates for an angular displacement corresponding to a preset amount of media to displace media from/to the roller 110. At block 520, the controller 140 is to determine the roller media advancement based on the angular displacement and the radius of the media roll 120. The media roll 120 includes the rolled media on the roller 110. At block 530 the media advancement sensor 130 may measure the media advancement of the media 125. At block 540, the controller 140 may determine a displacement difference between the measured media advancement (e.g., block 530) and the roller media advancement (e.g., block 520). At block 550, upon determining that the displacement difference (e.g., block 540) exceeds a predetermined threshold (see, e.g., FIG. 2), the controller 140 may detect that a telescopic effect occurred. After executing block 550 the method may end or may re-iterate to, for example, block 510.

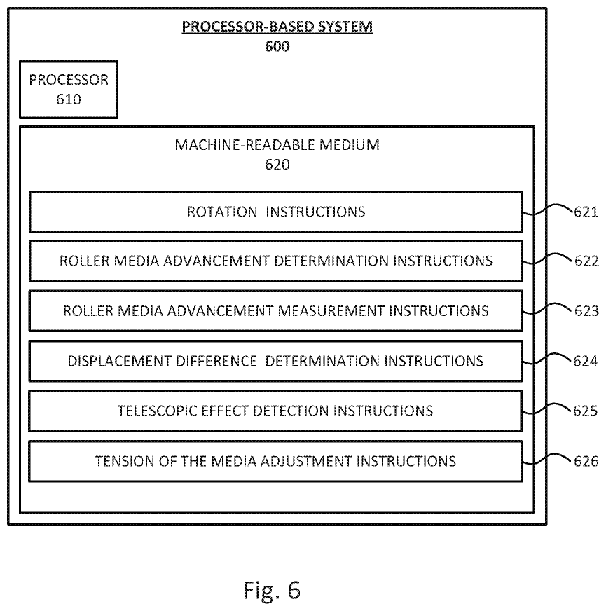

FIG. 6 is a block diagram illustrating an example of a processor-based system 600 that includes a machine-readable medium 620 encoded with example instructions to detect a telescoping effect. In some implementations, the system 600 is a processor-based system and may include a processor 610 coupled to a machine-readable medium 620. The processor 610 may include a single-core processor, a multi-core processor, an application-specific integrated circuit (ASIC), a field programmable gate array (FPGA), and/or any other hardware device suitable for retrieval and/or execution of instructions from the machine-readable medium 620 (e.g., instructions 621-626) to perform functions related to various examples. Additionally, or alternatively, the processor 610 may include electronic circuitry for performing the functionality described herein, including the functionality of instructions 621-626. With respect of the executable instructions represented as boxes in FIG. 6, it should be understood that part or all of the executable instructions and/or electronic circuits included within one box may, in alternative implementations, be included in a different box shown in the figures or in a different box not shown.

The machine-readable medium 620 may be any medium suitable for storing executable instructions, such as a random-access memory (RAM), electrically erasable programmable read-only memory (EEPROM), flash memory, hard disk drives, optical disks, and the like. In some example implementations, the machine-readable medium 620 may be a tangible, non-transitory medium, where the term “non-transitory” does not encompass transitory propagating signals. The machine-readable medium 620 may be disposed within the processor-based system 600, as shown in FIG. 6, in which case the executable instructions may be deemed “installed” on the system 600. Alternatively the machine-readable medium 620 may be a portable (e.g., external) storage medium, for example, that allows system 600 to remotely execute the instructions or download the instructions from the storage medium. In this case, the executable instructions may be part of an “installation package”. As described further herein below, the machine-readable medium may be encoded with a set of executable instructions 621-626

Instructions 621, when executed by the processor 610, may cause the processor 610 to rotate a shaft (e.g., spindle 115) from a roller 110 for an angular displacement corresponding to a preset amount of media to displace media from/to the roller 110.

Instructions 622, when executed by the processor 610, may cause the processor 610 to determine the roller media advancement based on the angular displacement and a radius of a media roll 120. The media roll 120 is to include the roller and the rolled media thereon.

Instructions 623, when executed by the processor 610, may cause the processor 610 to measure a media advancement by a media advancement sensor 130.

Instructions 624, when executed by the processor 610, may cause the processor 610 to determine a displacement difference between the measured media advancement and the roller media advancement.

Instructions 625, when executed by the processor 610, may cause the processor 610 to detect that a telescopic effect occurred upon determining that the displacement difference exceeds a predetermined threshold (see, e.g., FIG. 2).

Instructions 626, when executed by the processor 610 and based on the detection that the telescopic effect occurred, may cause the processor 610 to adjust a tension of the media when the roller 115 is either rolling or unrolling the media thereon.

The above examples may be implemented by hardware, or software in combination with hardware. For example, the various methods processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processors, or a combination thereof.

As used herein, the terms “about” and “substantially” are used to provide flexibility to a numerical range endpoint by providing that a given value may be, for example, an additional 20% more or an additional 20% less than the endpoints of the range. The degree of flexibility of this term can be dictated by the particular variable and would be within the knowledge of those skilled in the art to determine based on experience and the associated description herein.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

There have been described example implementations with the following sets of features:

Feature set 1: A system comprising:
a roller with a spindle being the roller to wind and/or unwind a roll of media;
a media advancement sensor to measure the advancement of the media; and
a controller to:
   control the spindle to rotate an angular displacement;
   determine a calculated media advancement based on the angular displacement and a radius of the roll of media,
   receive from the media advancement sensor a measured media advancement; and
   detect that a displacement difference between the measured media advancement and the determined media advancement exceeds a predetermined threshold, if the displacement difference exceeds the predetermined threshold a slippage condition is detected.

Feature set 2: A system with feature set 1, wherein the controller is to control the roller torque to adjust the tension of the media based on the detection of the slippage condition.

Feature set 3: A system with any preceding feature set 1 or 2, wherein the controller is to control the roller torque while the roller is either winding or unwinding the media thereon.

Feature set 4: A system with any preceding feature set 1 to 3, wherein the controller controls the roller torque based on at least one of the radius of the roller, the media friction coefficient, the number of layers of media on the roller, a media roll weight and an actual roller torque.

Feature set 5: A system with any preceding feature set 1 to 4, wherein the controller is to update the radius of the media roll based on the angular displacement.

Feature set 6: A system with any preceding feature set 1 to 5, wherein the media is a transfer media.

Feature set 7: A system with any preceding feature set 1 to 6, wherein the roller is a media input roller or a media output roller.

Feature set 8: A system with any preceding feature set 1 to 7, further comprising the other of the media input roller or the media output roller, wherein the media output roller is to wind a part of the media previously unwind by the media input roller.

Feature set 9: A system with any preceding feature set 1 to 8, further comprising a printing module to eject printing fluid on the media based on an image to be printed.

Feature set 10: A system with any preceding feature set 1 to 9, wherein the controller is to decrease the roller torque as a media roll external radius decreases.

Feature set 11: A method comprising:
rotating a spindle from a roller for an angular displacement corresponding to a preset amount of media to displace media from/to the roller;
determining the roller media advancement based on the angular displacement and a radius of a media roll, wherein the media roll comprises the roller and the rolled media thereon;
measuring a media advancement by a media advancement sensor;
determining a displacement difference between the measured media advancement and the roller media advancement; and
detecting that a telescopic effect occurred upon determining that the displacement difference exceeds a predetermined threshold.

Feature set 12: A method with any preceding feature set 11, further comprising adjusting a tension of the media based on the detection that the telescopic effect occurred.

Feature set 13: A method with any preceding feature set 11 to 12, further comprising adjusting the tension of the media when the roller is either rolling or unrolling the media thereon.

Feature set 14: A method with any preceding feature set 11 to 13, further comprising updating the radius of the media roll based on the angular displacement.

Feature set 15: A non-transitory machine-readable medium storing instructions executable by a processor, the non-transitory machine-readable medium comprising:
instructions to rotate a shaft from a roller for an angular displacement corresponding to a preset amount of media to displace media from/to the roller;
instructions to determine the roller media advancement based on the angular displacement and a radius of a media roll, wherein the media roll comprises the roller and the rolled media thereon;
instructions to measure a media advancement by a media advancement sensor;
instructions to determine a displacement difference between the measured media advancement and the roller media advancement;
instructions to detect that a telescopic effect occurred upon determining that the displacement difference exceeds a predetermined threshold; and
instructions to adjust a tension of the media when the roller is either rolling or unrolling the media thereon based on the detection that the telescopic effect occurred.

What itis claimed is:

1. A system comprising:
a roller with a spindle being the roller to wind and/or unwind a roll of media;
a media advancement sensor to measure the advancement of the media; and
a controller to:
control the spindle to rotate an angular displacement;
determine a calculated media advancement based on the angular displacement and a radius of the roll of media,
receive from the media advancement sensor a measured media advancement; and
detect that a displacement difference between the measured media advancement and the determined media advancement exceeds a predetermined threshold, if the displacement difference exceeds the predetermined threshold a slippage condition is detected.

2. The system of claim 1, wherein the controller is to control the roller torque to adjust the tension of the media based on the detection of the slippage condition.

3. The system of claim 2, wherein the controller is to control the roller torque while the roller is either winding or unwinding the media thereon.

4. The system of claim 2, wherein the controller controls the roller torque based on at least one of the radius of the roller, the media friction coefficient, the number of layers of media on the roller, a media roll weight and an actual roller torque.

5. The system of claim 1, wherein the controller is to update the radius of the media roll based on the angular displacement.

6. The system of claim 1, wherein the media is a transfer media.

7. The system of claim 1, wherein the roller is a media input roller or a media output roller.

8. The system of claim 7, further comprising the other of the media input roller or the media output roller, wherein the media output roller is to wind a part of the media previously unwind by the media input roller.

9. The system of claim 1, further comprising a printing module to eject printing fluid on the media based on an image to be printed.

10. The system of claim 1, wherein the controller is to decrease the roller torque as a media roll external radius decreases.

11. A method comprising:
rotating a spindle from a roller for an angular displacement corresponding to a preset amount of media to displace media from/to the roller;
determining the roller media advancement based on the angular displacement and a radius of a media roll, wherein the media roll comprises the roller and the rolled media thereon;
measuring a media advancement by a media advancement sensor;
determining a displacement difference between the measured media advancement and the roller media advancement; and
detecting that a telescopic effect occurred upon determining that the displacement difference exceeds a predetermined threshold.

12. The method of claim 11, further comprising adjusting a tension of the media based on the detection that the telescopic effect occurred.

13. The method of claim 12, further comprising adjusting the tension of the media when the roller is either rolling or unrolling the media thereon.

14. The method of claim 11, further comprising updating the radius of the media roll based on the angular displacement.

15. A non-transitory machine-readable medium storing instructions executable by a processor, the non-transitory machine-readable medium comprising:
instructions to rotate a shaft from a roller for an angular displacement corresponding to a preset amount of media to displace media from/to the roller;
instructions to determine the roller media advancement based on the angular displacement and a radius of a media roll, wherein the media roll comprises the roller and the rolled media thereon;
instructions to measure a media advancement by a media advancement sensor;
instructions to determine a displacement difference between the measured media advancement and the roller media advancement;
instructions to detect that a telescopic effect occurred upon determining that the displacement difference exceeds a predetermined threshold; and
instructions to adjust a tension of the media when the roller is either rolling or unrolling the media thereon, based on the detection that the telescopic effect occurred.
